(19) United States
(12) Patent Application Publication
(10) Pub. No.: US 2023/0408266 A1
(43) Pub. Date: Dec. 21, 2023

(54) ROAD BRIGHTNESS ROUTE PLANNING

(71) Applicant: GM Global Technology Operations LLC, Detroit, MI (US)

(72) Inventors: Kamran Ali, Troy, MI (US); Donald K. Grimm, Utica, MI (US)

(21) Appl. No.: 17/836,217

(22) Filed: Jun. 9, 2022

(51) Int. Cl. G01C 21/34; G01C 21/36; H04W 4/40; G06V 10/60; G06V 10/25; G06V 10/80; G06V 20/56

(52) U.S. Cl. CPC G01C 21/3415; G01C 21/3691; G01C 21/3461; G01C 21/3492; G01C 21/3602; G06V 20/56; H04W 4/40; G06V 10/60; G06V 10/25; G06V 10/80; G01C 21/3647

(57) ABSTRACT

A system for providing route guidance based on road brightness metrics includes a primary vehicle having an on-board data processor, a driver interface in communication with the on-board data processor and adapted to allow a driver to interact with the on-board data processor, and a wireless communication module, a cloud-based data processor adapted to collect real-time road brightness data from the primary vehicle and a plurality of other vehicles and to store collected data and build a model of road brightness metrics, the cloud-based data processor further adapted to receive data related to a starting position and final destination, calculate brightness characteristics for a shortest path route and at least one viable alternate route between the starting point and the final destination, and present to a driver of the primary vehicle the at least one viable alternate route which satisfies pre-determined brightness preferences better than the shortest path route.

The present disclosure relates to a system and method of providing route guidance based on road brightness metrics. When a driver in a vehicle selects a final destination, a navigation system will provide a preferred route that is typically based on the shortest overall distance to the final destination. Sometimes, a navigation system will provide alternate routes that avoid things like constructions zones, active accident scenes, dirt roads and toll roads. These alternate routes will typically take a little more time to arrive at the final destination, but allow the vehicle to selectively avoid undesirable driving conditions.

During the night, roadways exhibit varying levels of brightness based on the presence of street-lights, ambient light from businesses and buildings along the roadway, and the amount of traffic on the roadway. Current navigation systems do not provide guidance to a driver to allow a driver to select a route that provides better brightness characteristics over another route.

Thus, while current systems and methods achieve their intended purpose, there is a need for a new and improved system and method for providing route guidance based on road brightness metrics.

### SUMMARY

According to several aspects of the present disclosure, a system for providing route guidance based on road brightness metrics includes a primary vehicle having an on-board data processor, a driver interface in communication with the on-board data processor and adapted to allow a driver of the vehicle to receive information from the on-board data processor and to input information to the on-board data processor, and a wireless communication module in communication with the on-board data processor, a cloud-based data processor adapted to collect real-time road brightness data from the primary vehicle and a plurality of other vehicles and to store collected road brightness data from the primary vehicle and the plurality of other vehicles and to build a model of road brightness metrics at identified road segments at different times and different dates, the cloud-based data processor further adapted to receive data related to a starting position and final destination of the primary vehicle from the on-board data processor within the primary vehicle, calculate brightness characteristics for a shortest path route between the starting point and the final destination, calculate brightness characteristics for at least one viable alternate route between the starting point and the final destination, and present to a driver of the primary vehicle, via the driver interface within the primary vehicle, the at least one viable alternate route between the starting point and the final destination, when the at least one viable alternate route has brightness characteristics which satisfy pre-determined brightness preferences better than the shortest path route between the starting point and the final destination.

According to another aspect, when calculating brightness characteristics for at least one viable alternate route between the starting point and the final destination, the cloud-based data processor is further adapted to identify at least one viable alternate route that has an arrival time within a pre-determined time internal of an arrival time for the shortest path route.

According to another aspect, the cloud-based data processor is further adapted to collect real-time data related to brightness characteristics for the at least one viable alternate route from other vehicles traveling on the at least one alternate route, wherein, when calculating brightness characteristics for the at least one viable alternate route between the starting point and the final destination, the cloud-based data processor is adapted to combine historical data stored within the model of road brightness metrics on the cloud-based data processor related to brightness characteristics of the at least one viable alternate route with the real-time data collected from other vehicles traveling on the at least one alternate route.

According to another aspect, the cloud-based data processor is further adapted to collect real-time data related to brightness characteristics for the shortest path route from other vehicles traveling on the shortest path route and from the primary vehicle, wherein when calculating brightness characteristics for the shortest path route between the starting point and the final destination, the cloud-based data processor is further adapted to combine historical data stored within the model of road brightness metrics on the cloud-based data processor related to brightness characteristics of the shortest path route with the real-time data collected from other vehicles traveling on the shortest path route and from the primary vehicle.

According to another aspect, the on-board data processor within the primary vehicle and on-board data processors within each of the other vehicles are adapted to collect images from a plurality of on-board image capturing devices, calculate, with the on-board data processor, a brightness metric for each captured image from each of the plurality of image capturing devices, calculate a median brightness metric for the captured images over the identified road segments, attach GPS coordinates, heading information and timestamps to the median brightness metrics, and send, via a wireless communication module, over a wireless communication network, the median brightness metrics to the cloud-based data processor.

According to another aspect, the on-board data processors within each of the primary vehicle and the other vehicles are adapted to ROI filter each of the captured images from each of the plurality of image capturing devices prior to calculating the brightness metric for each captured image.

According to another aspect, when combining historical data stored within the model of road brightness metrics on the cloud-based data processor related to brightness characteristics of the at least one viable alternate route with the real-time data collected from other vehicles traveling on the at least one alternate route, the cloud-based data processor is further adapted to identify the plurality of identified road segments of the at least one viable alternate route, and for each of the identified road segments of the at least one viable route, fuse the median brightness metrics for each of the identified road segments received from the other vehicles with historical data for each of the identified road segments stored within the model of road brightness metrics on the cloud-based data processor to calculate brightness characteristics for each of the plurality of pre-determined road segments of the at least one alternate route.

According to another aspect, when combining historical data stored within the model of road brightness metrics on the cloud-based data processor related to brightness characteristics of the shortest path route with the real-time data collected from other vehicles traveling on the shortest path route and from the primary vehicle, the cloud-based data processor is further adapted to identify the plurality of identified road segments of the shortest path route, and for each of the identified road segments of the shortest path route, fuse the median brightness metrics for each of the identified road segments received from other vehicles and the primary vehicle with historical data for the identified road segments stored within the model of road brightness metrics on the cloud-based data processor to calculate brightness characteristics for each of the plurality of pre-determined road segments of the shortest path route.

According to another aspect, when presenting to the driver of the primary vehicle, via a driver interface within the primary vehicle, the at least one viable alternate route between the starting point and the final destination, when the at least one viable alternate route has brightness characteristics which satisfy pre-determined brightness preferences better than the shortest path route between the starting point and the final destination, the cloud-based data processor is further adapted to collect, with the driver interface within the primary vehicle, driver preferences related to brightness metrics, compare each of the identified road segments of the at least one viable alternate route with the driver preferences, compare each of the identified road segments of the shortest path route with the driver preferences, and identify each of the at least one viable alternate route that more closely satisfies the driver preferences than the shortest path route.

According to another aspect, after calculating brightness characteristics for each of the plurality of pre-determined road segments of the at least one alternate route and calculating brightness characteristics for each of the plurality of identified road segments of the shortest path route, the cloud-based data processor is further adapted to update the model of road brightness metrics at identified road segments at different times and different dates.

According to several aspects of the present disclosure, a method of providing route guidance based on road brightness metrics includes collecting, with a cloud-based data processor adapted to collect real-time road brightness data from the primary vehicle and a plurality of other vehicles and to store collected road brightness data from the primary vehicle and the plurality of other vehicles and to build a model of road brightness metrics at identified road segments at different times and different dates, a starting position and final destination of a primary vehicle from a processor within the primary vehicle, calculating brightness characteristics for a shortest path route between the starting point and the final destination, calculating brightness characteristics for at least one viable alternate route between the starting point and the final destination, presenting to the driver of the primary vehicle, via a driver interface within the primary vehicle, the at least one viable alternate route between the starting point and the final destination, when the at least one viable alternate route has brightness characteristics which satisfy pre-determined brightness preferences better than the shortest path route between the starting point and the final destination.

According to another aspect, the calculating brightness characteristics for at least one viable alternate route between the starting point and the final destination further includes identifying at least one viable alternate route that has an arrival time within a pre-determined time internal of an arrival time for the shortest path route.

According to another aspect, the calculating brightness characteristics for the at least one viable alternate route between the starting point and the final destination further includes collecting, with the cloud-based data processor, real-time data related to brightness characteristics for the at least one viable alternate route from other vehicles traveling on the at least one alternate route, and combining historical data stored within the model of road brightness metrics on the cloud-based data processor related to brightness characteristics of the at least one viable alternate route with the real-time data collected from other vehicles traveling on the at least one alternate route.

According to another aspect, the calculating brightness characteristics for the shortest path route between the starting point and the final destination further includes collecting, with the cloud-based data processor, real-time data related to brightness characteristics for the shortest path route from other vehicles traveling on the shortest path route and from the primary vehicle, and combining historical data stored within the model of road brightness metrics on the cloud-based data processor related to brightness characteristics of the shortest path route with the real-time data collected from other vehicles traveling on the shortest path route and from the primary vehicle.

According to another aspect, the collecting, with the cloud-based data processors within the primary vehicle and each of the other vehicles, real-time data from the primary vehicle and the other vehicles, further includes collecting images from a plurality of on-board image capturing devices with an on-board data processor, calculating, with the on-board data processor, a brightness metric for each captured image from each of the plurality of image capturing devices, calculating a median brightness metric for the captured images over the identified road segments, attaching GPS coordinates, heading information and timestamps to the median brightness metrics, and sending, via a wireless communication module, over a wireless communication network, the median brightness metrics to the cloud-based data processor.

According to another aspect, the method further includes ROI filtering each of the captured images from each of the plurality of image capturing devices prior to calculating the brightness metric for each captured image.

According to another aspect, the combining historical data stored within the model of road brightness metrics on the cloud-based data processor related to brightness characteristics of the at least one viable alternate route with the real-time data collected from other vehicles traveling on the at least one alternate route further includes identifying, with the cloud-based data processor, the identified road segments of the at least one viable alternate route, and for each of the identified road segments of the at least one viable route, fusing the median brightness metrics for each of the identified road segments received from other vehicles with historical data for each of the identified road segments stored within the model of road brightness metrics on the cloud-based data processor to calculate brightness characteristics for each of the plurality of identified road segments of the at least one alternate route.

According to another aspect, the combining historical data stored within the model of road brightness metrics on the cloud-based data processor related to brightness characteristics of the shortest path route with the real-time data collected from other vehicles traveling on the shortest path route and from the primary vehicle further includes identifying, with the cloud-based data processor, the identified road segments of the shortest path route, and for each of the identified road segments of the shortest path route, fusing the median brightness metrics for each of the identified road segments received from other vehicles and the primary vehicle with historical data for the identified road segments stored within the model of road brightness metrics on the cloud-based data processor to calculate brightness characteristics for each of the plurality of identified road segments of the shortest path route.

According to another aspect, the presenting to the driver of the primary vehicle, via a driver interface within the primary vehicle, the at least one viable alternate route between the starting point and the final destination, when the at least one viable alternate route has brightness characteristics which satisfy pre-determined brightness preferences better than the shortest path route between the starting point and the final destination further includes collecting, with the driver interface within the primary vehicle, driver preferences related to brightness metrics, comparing each of the identified road segments of the at least one viable alternate route with the driver preferences, comparing each of the identified road segments of the shortest path route with the driver preferences, and identifying each of the at least one viable alternate route that more closely satisfies the driver preferences than the shortest path route.

According to another aspect, the method further includes, after calculating brightness characteristics for each of the plurality of identified road segments of the at least one alternate route and calculating brightness characteristics for each of the plurality of identified road segments of the shortest path route, updating the model of road brightness metrics at identified road segments at different times and different dates.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic view of a system according to an exemplary embodiment of the present disclosure;

FIG. 2 is a schematic view of a shortest path route and a viable alternate route between a starting point and a final destination according to an exemplary embodiment;

FIG. 3 is a schematic diagram of a three-dimensional color space;

FIG. 4 is a graph of brightness characteristics for the shortest path route shown in FIG. 2;

FIG. 5 is a graph of brightness characteristics for the viable alternate route shown in FIG. 2;

FIG. 6 is a schematic flow chart illustrating a method of providing route guidance based on road brightness metrics according to an exemplary embodiment; and

FIG. 7 is a schematic flow chart illustrating details of boxes 110 and 114 from FIG. 6.

The figures are not necessarily to scale and some features may be exaggerated or minimized, such as to show details of particular components. In some instances, well-known components, systems, materials or methods have not been described in detail in order to avoid obscuring the present disclosure. Therefore, specific structural and functional details disclosed herein are not to be interpreted as limiting, but merely as a basis for the claims and as a representative basis for teaching one skilled in the art to variously employ the present disclosure.

### DETAILED DESCRIPTION

The following description is merely exemplary in nature and is not intended to limit the present disclosure, application, or uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality. Although the figures shown herein depict an example with certain arrangements of elements, additional intervening elements, devices, features, or components may be present in actual embodiments. It should also be understood that the figures are merely illustrative and may not be drawn to scale.

As used herein, the term “vehicle” is not limited to automobiles. While the present technology is described primarily herein in connection with automobiles, the technology is not limited to automobiles. The concepts can be used in a wide variety of applications, such as in connection with aircraft, marine craft, other vehicles, and consumer electronic components.

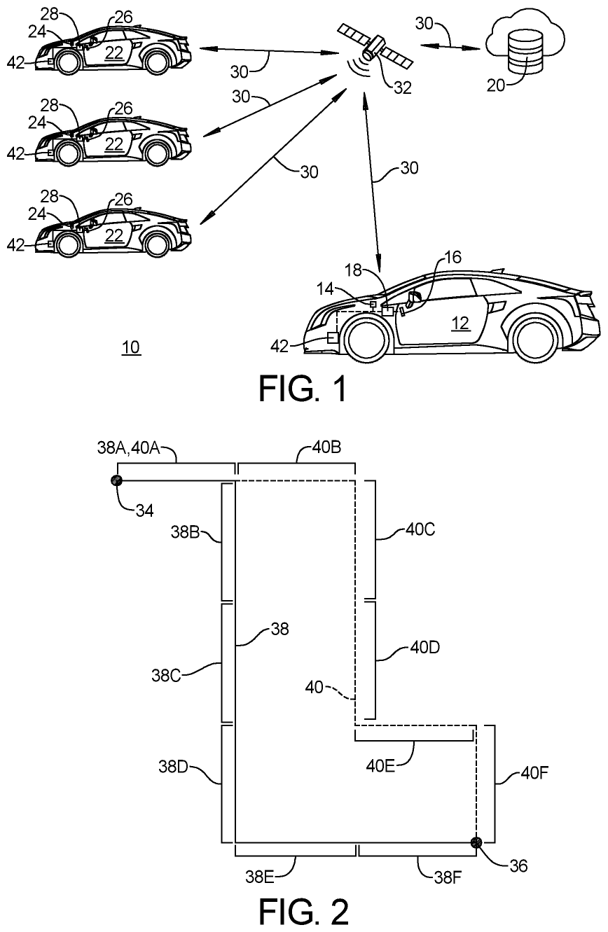

Referring to FIG. 1, a system 10 for providing route guidance to a primary vehicle 12 based on road brightness metrics includes an on-board data processor 14 positioned within the primary vehicle 12. A driver interface 16 is positioned within the primary vehicle 12 for interaction with a driver of the primary vehicle 12 and is in communication with the on-board data processor 14. The driver interface 16 is adapted to allow the driver of the primary vehicle 12 to receive information from the on-board data processor 14 and to input information to the on-board data processor 14. A wireless communication module 18 is positioned within the primary vehicle 12, in communication with the on-board data processor 14.

A cloud-based data processor 20 is adapted to collect real-time road brightness data from the primary vehicle 12 and a plurality of other vehicles 22. Other vehicles 22 are vehicles that also have an on-board data processor 24, a driver interface 26, and a wireless communication module 28. The wireless communication modules 18, 28 within the primary vehicle 12 and the other vehicles 22 allow wireless bi-directional communication between the on-board data processors 14, 24 of each of the primary vehicle 12 and the other vehicles 22 and the cloud-based data processor 20, as indicated by arrows 30. Wireless communication, with the wireless communication modules 18, 28 is enabled via a wireless data communication network 32 over wireless communication channels such as a WLAN, 4G/LTE or 5G network, or the like.

The cloud-based data processor 20 and each of the on-board data processors 14, 24 is a non-generalized, electronic control device having a preprogrammed digital computer or processor, memory or non-transitory computer readable medium used to store data such as control logic, software applications, instructions, computer code, data, lookup tables, etc., and a transceiver [or input/output ports]. computer readable medium includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device. Computer code includes any type of program code, including source code, object code, and executable code.

The cloud-based data processor 20 is adapted to store collected road brightness data from the primary vehicle 12 and the plurality of other vehicles 22 and to build a model of road brightness metrics at identified road segments at different times and different dates. In an exemplary embodiment, the cloud-based data processor 20 is further adapted to receive data related to a starting position 34 and final destination 36 of the primary vehicle 12 from the on-board data processor 14 within the primary vehicle 12. A driver may select the final destination 36 via the driver interface 16 within the primary vehicle 12.

The cloud-based data processor 20 is further adapted to calculate brightness characteristics for a shortest path route 38 between the starting point 34 and the final destination 36. The shortest path route 38 is the default route selected by the system 10 or by a navigation system working in conjunction with the system 10 within the primary vehicle 12, and is typically the route that provides the shortest actual travel distance between the starting point 34 and the final destination 36.

The cloud-based data processor 20 is further adapted to calculate brightness characteristics for at least one viable alternate route 40 between the starting point 34 and the final destination 36. In an exemplary embodiment, the at least one viable alternate route 40 is any route that has an arrival time at the final destination 36 that is within a pre-determined time internal of an arrival time at the final destination 36 for the shortest path route 38. For example, referring to FIG. 2, the system 10 identifies the shortest path route 38 and displays the shortest path route 38 as a solid line on the driver interface 16. The driver interface 16 will also display the approximate travel time to the final destination 36 for the shortest path route 38. For this example, the travel time from the starting point 34 to the final destination 36 along the shortest path route 38 is fifteen minutes. For this example, the pre-determined time interval is five minutes. Thus, any route that provides a travel time within five minutes of the approximate travel time along the shortest path route 38 is a viable alternate route 40. In other words, any route that provides a travel time that is twenty minutes or less would be considered a viable alternate route 40.

The cloud-based data processor 20 is further adapted to present to the driver of the primary vehicle 12, via the driver interface 16 within the primary vehicle 12, the at least one viable alternate route 40 between the starting point 34 and the final destination 36, when the at least one viable alternate route 40 has brightness characteristics which satisfy pre-determined brightness preferences better than the shortest path route 38 between the starting point 34 and the final destination 36. As shown in FIG. 2, the system displays a viable alternate route 40 between the starting point 34 and the final destination 36 as a dashed line. The system 10 further displays information to the driver related to the viable alternate route 40, informing the driver of the approximate drive time, and why the viable alternate route 40 may be preferred. For example, the system 10 may display a message indicating that the displayed viable alternate route 40 will take seventeen minutes, two minutes longer than the shortest path route 38, but that the displayed viable alternate route 40 provides better road brightness characteristics than the shortest path route 38.

In an exemplary embodiment, after the cloud-based data processor 20 identifies at least one viable alternate route 40, the cloud-based data processor 20 is further adapted to collect real-time data related to brightness characteristics for the at least one viable alternate route 40 from other vehicles 22 traveling on the at least one viable alternate route 40. The system 10 identifies other vehicles 22 that are currently travelling on the at least one viable alternate route 40 and initiates collection of data from the other vehicles 22 via the wireless communication network 32. The cloud-based data processor 20 is further adapted to collect real-time data related to brightness characteristics for the shortest path route 38 from other vehicles 22 traveling on the shortest path route 38 and from the primary vehicle 12 which is currently traveling on the shortest path route 38. The system 10 identifies other vehicles 22 that are currently travelling on the shortest path route 38 and initiates collection of data from the other vehicles 22 and the primary vehicle 12 via the wireless communication network 32.

When calculating brightness characteristics for the at least one viable alternate route 40 between the starting point 34 and the final destination 36, the cloud-based data processor 20 is adapted to combine historical data stored within the model of road brightness metrics on the cloud-based data processor 20 related to brightness characteristics of the at least one viable alternate route 40 with the real-time data collected from other vehicles 22 traveling on the at least one alternate route 40. When calculating brightness characteristics for the at least one viable alternate route 40 between the starting point 34 and the final destination 36, the cloud-based data processor 20 is further adapted to combine historical data stored within the model of road brightness metrics on the cloud-based data processor 20 related to brightness characteristics of the shortest path route 38 with the real-time data collected from other vehicles 22 traveling on the shortest path route 38 and from the primary vehicle 12.

In an exemplary embodiment, the primary vehicle 12 and the other vehicles 22 each include a plurality of on-board image capturing devices 42, such as cameras, in communication with the on-board data processors 14, 24 and adapted to obtain periodic or sequential images of the environment surrounding the vehicles 12, 22. The on-board data processor 14 within the primary vehicle 12 and on-board data processors 24 within each of the other vehicles 22 are adapted to collect images from the plurality of on-board image capturing devices 42, and to calculate a brightness metric for each captured image from each of the plurality of image capturing devices 42.

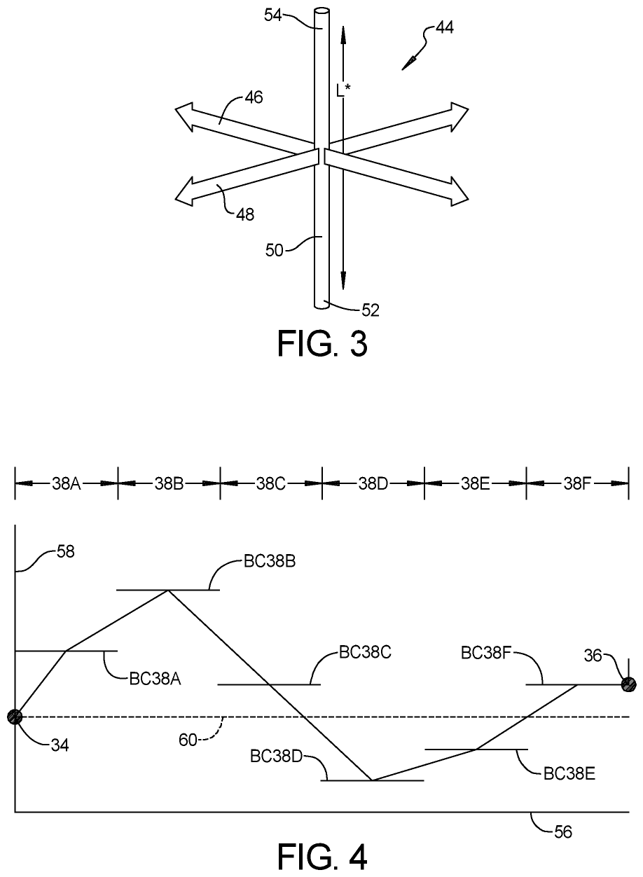

In an exemplary embodiment, for the primary vehicle 12 and each of the other vehicles 22, the onboard data processor 14, 24 converts each image collected into a three-dimensional color space 44. Referring to FIG. 3, a three-dimensional L*a*b* color space 44 is represented wherein the x-axis 46 and the y-axis 48 represent the primary colors and the z-axis 50 represents perceptual brightness L* in a range from 0, at a first end 52 of the spectrum to 100 at a second end 54 of the spectrum. For each image, the brightness metric is calculated by taking the average of the perceptual brightness L* values of all the pixels within the image.

In an exemplary embodiment, the on-board data processors 14, 24 within each of the primary vehicle 12 and the other vehicles 22 are adapted to ROI (region of interest) filter each of the captured images from each of the plurality of image capturing devices 42 prior to calculating the brightness metric for each captured image. ROI filtering is the process of applying a filter to a region in an image. For example, an image may capture the roadway in front of a vehicle, as well as areas to the side of the roadway. The roadway may be well lighted by focused street-lights, wherein the areas to the side of the roadway may be completely dark. The system 10 is primarily interested in the brightness characteristics of the roadway, thus the areas to the side of the roadway may be filtered out so the overall brightness metric for the image is not negatively affected by irrelevant dark areas to the side of the roadway. For each image, the brightness metric is calculated by taking the average of the perceptual brightness L* values of all the pixels within the image, except the pixels that are excluded by ROI filtering.

When ROI filtering captured images, the system 10 must account for motion of the vehicle, and the on-board image capturing devices 42, relative to the roadway. If the roadway is rough, and the vehicle and the cameras 42 bounce up and down the filter must be moved to account for such movement and remain focused on the areas intended to be filtered. For example, if the camera moves upward, then the filter should be moved downward to make sure the filter is still focused on the intended area.

Further, the system 10 may be adapted to remove pixels within each image that correspond to moving objects. As the on-board data processors 14, 24 collect images via the plurality of image capturing devices 42, a series of images from an individual camera 42 may capture an on-coming vehicle on the roadway moving in the opposite direction. As this on-coming vehicle approaches, the brightness of the images will dramatically increase as the headlights of the on-coming vehicle get closer, and then the brightness will dramatically fall off when the on-coming vehicle has passed. The system 10 may identify such anomalies and filter out images that have captured moving objects. Further, for the purposes of updating the model, discussed further below, data collected at low traffic times may be weighted more than data collected at high traffic times to prevent the historical data within the model from being biased due to higher traffic affecting the calculated brightness characteristics.

In an exemplary embodiment, the system 10 is adapted to weigh images from cameras 42 that are directed primarily on the roadway more when calculating brightness metrics. Many vehicles have cameras facing 360 degrees around the vehicle. The system 10 is primarily focused on the brightness characteristics on the roadway itself, so when collecting images from all of the cameras 42 on a vehicle, the system 10 may weigh images from cameras focused on the roadway more than images from cameras focused around the vehicle when calculating brightness metrics.

Then, for the primary vehicle 12 and each of the other vehicles 22, the onboard data processor 14, 24 calculates a median brightness metric for the captured images over pre-determined road segments. In an exemplary embodiment, the system 10 identifies road segments of a pre-determined length and calculates the brightness metrics for each road segment 56. For example, referring again to FIG. 2, the shortest path route 38 is divided into six road segments 38A, 38B, 38C, 38D, 38E, 38F, and the viable alternate route 40 is divided into six road segments 40A, 40B, 40C, 40D, 40E, 40F. For this example, the length of the road segments is 300 meters. As shown in FIG. 2, each of the shortest path route 38 and the viable alternative route 40 have the same number of road segments. It should be understood that the number of road segments in the shortest path route 38 is not necessarily the same as the number of road segments in any of the at least one viable alternate routes 40.

As the primary vehicle 12 or any of the other vehicles 22 travel, the plurality of image capturing devices 42 are continuously capturing images. For the primary vehicle 12 and each of the other vehicles 22, the onboard data processor 14, 24 calculates a median brightness metric for all of the images from all of the cameras 42 that were captured within an identified road segment. For example, when collecting data for the viable alternate route 40 shown in FIG. 2, the system 10 identifies a vehicle that is currently traveling on the viable alternate route 40, wherein, the identified other vehicle 22 will collect images and calculate a median brightness metric for each of the road segments 40A, 40C, 40D, 40E, 40F that such other vehicle 22 travels through.

For the primary vehicle 12 and each of the other vehicles 22, the onboard data processor 14, 24 is adapted to attach GPS coordinates, heading information and timestamps to the median brightness metrics, and to send, via a wireless communication module 18, 28, over the wireless communication network 32, the median brightness metrics to the cloud-based data processor 20.

In an exemplary embodiment, when combining historical data stored within the model of road brightness metrics on the cloud-based data processor 20 related to brightness characteristics of the shortest path route 38 with the real-time data collected from other vehicles 22 traveling on the shortest path route 38 and from the primary vehicle 12, the cloud-based data processor is further adapted to identify a plurality of pre-determined road segments 38A, 38B, 38C, 38D, 38E, 38F of the shortest path route 38, and for each of the identified road segments 38A, 38B, 38C, 38D, 38E, 38F of the shortest path route 38, fuse the median brightness metrics for each of the identified road segments 38A, 38B, 38C, 38D, 38E, 38F received from other vehicles 22 and the primary vehicle 12 with historical data for each of the identified road segments 38A, 38B, 38C, 38D, 38E, 38F stored within the model of road brightness metrics on the cloud-based data processor 20.

For example, as shown in FIG. 1, the system 10 is in communication with three other vehicles 22. The cloud-based data processor collects a median brightness metric from each of the three other vehicles 22 for each one of the road segments 38A, 38B, 38C, 38D, 38E, 38F of the shortest path route 38 travelled through. Additionally, the cloud-based data processor collects a median brightness metric from the primary vehicle 12 which is currently travelling on the shortest path route 38, as the primary vehicle 12 travels. For each of the road segments 38A, 38B, 38C, 38D, 38E, 38F of the shortest path route 38, the cloud-based data processor 20 averages the three median brightness metrics received from the three other vehicles 22 with historical brightness metrics for each of the road segments 38A, 38B, 38C, 38D, 38E, 38F stored within the model. Thus, the cloud-based data processor 20 calculates brightness characteristics for each of the plurality of pre-determined road segments 38A, 38B, 38C, 38D, 38E, 38F of the shortest path route 38.

In an exemplary embodiment, when combining historical data stored within the model of road brightness metrics on the cloud-based data processor 20 related to brightness characteristics of the at least one viable alternate route 40 with the real-time data collected from other vehicles 22 traveling on the at least one alternate route 40, the cloud-based data processor is further adapted to identify the plurality of pre-determined road segments 40B, 40C, 40D, 40E, 40F of the at least one viable alternate route 40, and for each of the identified road segments 40A, 40B, 40C, 40D, 40E, 40F of the at least one viable route 40, fuse the median brightness metrics for each of the identified road segments 40A, 40B, 40C, 40D, 40E, 40F received from the other vehicles 22 with historical data for each of the identified road segments 40A, 40C, 40D, 40E, 40F stored within the model of road brightness metrics on the cloud-based data processor 20.

For example, referring again to FIG. 1, the system 10 is in communication with three other vehicles 22. The cloud-based data processor collects a median brightness metric from each of the three other vehicles 22 for each one of the road segments 40A, 40B, 40C, 40D, 40E, 40F of the viable alternate route 40 travelled through. For each of the road segments 40A, 40B, 40D, 40E, 40F of the viable alternate route 40, the cloud-based data processor 20 averages the three median brightness metrics received from the three other vehicles 22 with historical brightness metrics for each of the road segments 40A, 40B, 40C, 40D, 40E, 40F stored within the model. Thus, the cloud-based data processor 20 calculates brightness characteristics for each of the plurality of pre-determined road segments 40A, 40B, 40C, 40D, 40E, 40F of the at least one alternate route 40.

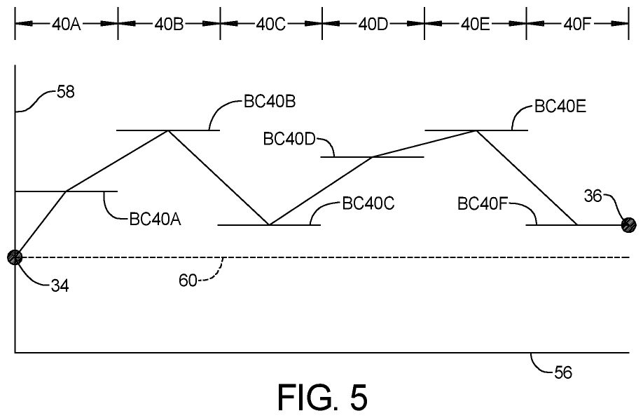

Referring to FIG. 4, a graph illustrates the brightness characteristics over each of the road segments 38A, 38B, 38C, 38D, 38E, 38F of the shortest path route 38. Referring to FIG. 5, a graph illustrates the brightness characteristics over each of the road segments 40A, 40B, 40C, 40D, 40F of the viable alternate route 40. An x-axis 56 of each graph represents distance travelled and a y-axis 58 of each graph represents the relative brightness characteristics. The line BC38A in the graph of FIG. 4 represents the brightness characteristic of the road segment 38A of the shortest path route 38, which comprises the average of the three median brightness metrics received from the three other vehicles 22 and the historical brightness metrics stored within the model for the road segment 38A of the shortest path route 38. The lines BC38B, BC38C, BC38D, BC38E, BC38F in the graph of FIG. 4 represent brightness characteristics of the corresponding road segments 38B, 38C, 38D, 38E, 38F of the shortest path route 38, respectively. The line BC40A in the graph of FIG. 5 represents the brightness characteristic of the road segment 40A of the viable alternate route 40, which comprises the average of the three median brightness metrics received from the three other vehicles 22 and the historical brightness metrics stored within the model for the road segment 40A of the viable alternate route. The lines BC40B, BC400, BC40D, BC40E, BC4OF in the graph of FIG. 5 represent brightness characteristics of the corresponding road segments 40B, 40C, 40D, 40E, 40F of the viable alternate route 40, respectively.

In an exemplary embodiment, when presenting to the driver of the primary vehicle 12, via the driver interface 16 within the primary vehicle 12, the at least one viable alternate route 40 between the starting point 34 and the final destination 36, when the at least one viable alternate route 40 has brightness characteristics which satisfy pre-determined brightness preferences better than the shortest path route 38 between the starting point 34 and the final destination 36, the cloud-based data processor 20 is further adapted to collect, with the driver interface 16 within the primary vehicle 12, driver preferences related to brightness metrics. The driver preferences related to brightness are an indicator of what brightness conditions the driver of the primary vehicle 12 prefers. For example, one such preference may be that the driver of the primary vehicle 12 does not want to drive through areas that are considered dark zones. A dark zone is a road segment that has brightness characteristic lower that a pre-determined threshold.

The cloud-based data processor 20 is adapted to compare each of the identified road segments 38A, 38B, 38C, 38D, 38E, 38F of the shortest path route 38 with the driver preferences. Referring to FIG. 4, the graph includes a dashed line that represents a brightness threshold 60. If any road segment has a brightness characteristic that is less than the brightness threshold 60, then that road segment will be considered a dark zone. As shown in FIG. 4, the fourth and fifth road segments 38D, 38E of the shortest path route have brightness characteristics BC38D, BC38E that fall below the threshold 60. Thus, the fourth and fifth road segments 38D, 38E of the shortest path route 38 are dark zones.

The cloud-based data processor 20 is adapted to compare each of the identified road segments 40A, 40B, 40C, 40D, 40E, 40F of the at least one viable alternate route 40 with the driver preferences. As shown in FIG. 5, none of the road segments 40A, 40B, 40C, 40D, 40E, 40F of the viable alternate route 40 fall below the threshold 60. Thus, the viable alternate route 40 has no dark zones.

The cloud-based data processor 20 is adapted to identify each of the at least one viable alternate route 40 that more closely satisfies the driver preferences than the shortest path route 38. In the example illustrated in FIG. 4 and FIG. 5, the shortest path route 38 has two dark zones and the viable alternate route 40 has no dark zones. Therefore, the viable alternate route 40 more closely satisfies the driver preference of not wanting to drive through dark zones, and would be presented to the driver of the primary vehicle 12 as a viable alternate route that may be preferred.

After calculating brightness characteristics for each of the plurality of pre-determined road segments 40A, 40B, 40C, 40D, 40E, 40F of the at least one viable alternate route 40 and calculating brightness characteristics for each of the plurality of pre-determined road segments 38A, 38B, 38C, 38D, 38E, 38F of the shortest path route 38, the cloud-based data processor 20 is adapted to update the model of road brightness metrics at identified road segments at different times and different dates. Thus, each time the system 10 is used, the model is updated. If brightness conditions within an area change, each time the system 10 is utilized, the model is updated, and changing conditions for that area are accounted for in the model.

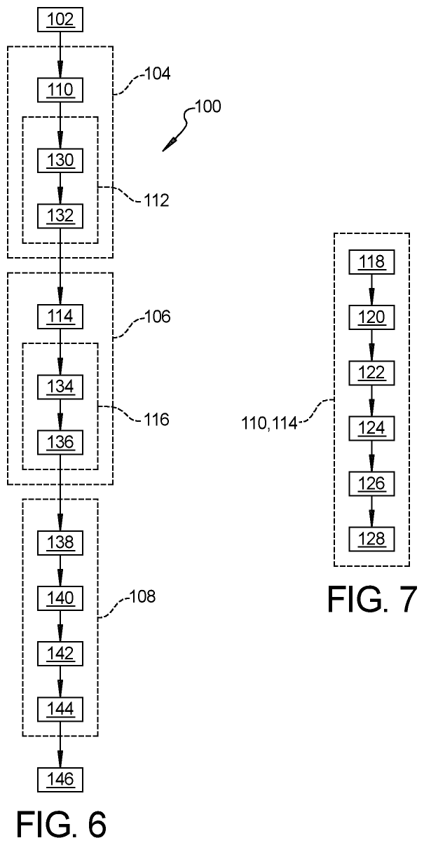

Referring to FIG. 6, a method 100 of providing route guidance based on road brightness metrics is shown. Beginning at block 102, the method includes collecting, with a cloud-based data processor 20 adapted to collect real-time road brightness data from the primary vehicle 12 and a plurality of other vehicles 22 and to store collected road brightness data from the primary vehicle 12 and the plurality of other vehicles 22 and to build a model of road brightness metrics at identified road segments 38A, 38B, 38C, 38D, 38E, 38F, 40B, 40C, 40D, 40E, 40F at different times and different dates, a starting position 34 and final destination 36 of the primary vehicle 12 from an on-board data processor 14 within the primary vehicle 12. Moving to block 104, the method 100 includes calculating brightness characteristics for a shortest path route 38 between the starting point 34 and the final destination 36, and moving to block 106, calculating brightness characteristics for at least one viable alternate route 40 between the starting point 34 and the final destination 36. Moving to block 108, the method 100 includes presenting to the driver of the primary vehicle 12, via a driver interface 16 within the primary vehicle 12, the at least one viable alternate route 40 between the starting point 34 and the final destination 36, when the at least one viable alternate route 40 has brightness characteristics which satisfy pre-determined brightness preferences better than the shortest path route 38 between the starting point 34 and the final destination 36.

In an exemplary embodiment, the calculating brightness characteristics for at least one viable alternate route 40 between the starting point 34 and the final destination 36 at block 106, further includes identifying at least one viable alternate route 40 that has an arrival time within a pre-determined time internal of an arrival time for the shortest path route 38.

In an exemplary embodiment, the calculating brightness characteristics for the shortest path route 38 between the starting point 34 and the final destination 36 at block 104, further includes, moving to block 110, collecting, with the cloud-based data processor 20, real-time data related to brightness characteristics for the shortest path route 38 from other vehicles 22 traveling on the shortest path route 38 and from the primary vehicle 12, and moving to block 112, combining historical data stored within the model of road brightness metrics on the cloud-based data processor 20 related to brightness characteristics of the shortest path route 38 with the real-time data collected from other vehicles 22 traveling on the shortest path route 38 and from the primary vehicle 12.

In another exemplary embodiment, the calculating brightness characteristics for the at least one viable alternate route 40 between the starting point 34 and the final destination 36 at block 106 further includes, moving to block 114, collecting, with the cloud-based data processor 20, real-time data related to brightness characteristics for the at least one viable alternate route 40 from other vehicles 22 traveling on the at least one viable alternate route 40, and, moving to block 116, combining historical data stored within the model of road brightness metrics on the cloud-based data processor 20 related to brightness characteristics of the at least one viable alternate route 40 with the real-time data collected from other vehicles 22 traveling on the at least one alternate route 40.

In an exemplary embodiment, the collecting, with the data processors 14, 24 within the primary vehicle 12 and each of the other vehicles 22, real-time data from the primary vehicle 12 and the other vehicles 22 at blocks 110 and 114, further includes, moving to block 118, collecting images from a plurality of on-board image capturing devices 42 with an on-board data processor 14, 24, moving to block 122, calculating, with the on-board data processor 14, 24, a brightness metric for each captured image from each of the plurality of image capturing devices 42, moving to block 124, calculating a median brightness metric for the captured images over pre-determined road segments 38A, 38B, 38C, 38D, 38E, 38F, 40A, 40B, 40C, 40D, 40E, 40F, moving to block 126, attaching GPS coordinates, heading information and timestamps to the median brightness metrics, and, moving to block 128, sending, via a wireless communication module 18, 28, over a wireless communication network 32, the median brightness metrics to the cloud-based data processor 20.

In an exemplary embodiment, moving to block 120, the method further includes ROI filtering each of the captured images from each of the plurality of image capturing devices 42 prior to calculating the brightness metric for each captured image.

In another exemplary embodiment, the combining historical data stored within the model of road brightness metrics on the cloud-based data processor 20 related to brightness characteristics of the shortest path route 38 with the real-time data collected from other vehicles 22 traveling on the shortest path route 38 and from the primary vehicle 12 at block 112, further includes, moving to block 130, identifying, with the cloud-based data processor 20, a plurality of pre-determined road segments 38A, 38B, 38C, 38D, 38E, 38F of the shortest path route 38, and for each of the identified road segments 38A, 38B, 38C, 38D, 38E, 38F of the shortest path route 38, and, moving to block 132, fusing the median brightness metrics for each of the identified road segments 38A, 38B, 38C, 38D, 38E, 38F received from other vehicles 22 and the primary vehicle 12 with historical data for each of the identified road segments 38A, 38B, 38C, 38D, 38E, 38F stored within the model of road brightness metrics on the cloud-based data processor 20 to calculate brightness characteristics for each of the plurality of pre-determined road segments 38A, 38B, 38C, 38D, 38E, 38F of the shortest path route 38.

The combining historical data stored within the model of road brightness metrics on the cloud-based data processor 20 related to brightness characteristics of the at least one viable alternate route 40 with the real-time data collected from other vehicles 22 traveling on the at least one alternate route 40 at block 116, further includes, moving to block 134, identifying, with the cloud-based data processor 20, a plurality of pre-determined road segments 40B, 40C, 40D, 40E, 40F of the at least one viable alternate route 40, and for each of the identified road segments 40A, 40B, 40C, 40D, 40E, 40F of the at least one viable route 40, and, moving to block 136, fusing the median brightness metrics for each of the identified road segments 40A, 40B, 40C, 40D, 40F received from other vehicles 22 with historical data for each of the identified road segments 40A, 40B, 40C, 40D, 40E, 40F stored within the model of road brightness metrics on the cloud-based data processor 20 to calculate brightness characteristics for each of the plurality of pre-determined road segments 40A, 40B, 40C, 40D, 40E, 40F of the at least one alternate route 40.

In another exemplary embodiment, the presenting to the driver of the primary vehicle 12, via a driver interface 16 within the primary vehicle 12, the at least one viable alternate route 40 between the starting point 34 and the final destination 36, when the at least one viable alternate route 40 has brightness characteristics which satisfy pre-determined brightness preferences better than the shortest path route 38 between the starting point 34 and the final destination 36 at block 108, further includes, moving to block 138, collecting, with the driver interface 16 within the primary vehicle 12, driver preferences related to brightness metrics, and moving to block 140, comparing each of the identified road segments 40A, 40B, 40C, 40D, 40E, 40F of the at least one viable alternate route 40 with the driver preferences, and moving to block 142, comparing each of the identified road segments 38A, 38B, 38C, 38D, 38E, 38F of the shortest path route 38 with the driver preferences, and, moving to block 144, identifying each of the at least one viable alternate route 40 that more closely satisfies the driver preferences than the shortest path route 38.

Finally, moving to block 146, the method 100 further includes after calculating brightness characteristics for each of the plurality of pre-determined road segments 40A, 40B, 40C, 40D, 40E, 40F of the at least one alternate route 40 and calculating brightness characteristics for each of the plurality of pre-determined road segments 38A, 38B, 38C, 38D, 38E, 38F of the shortest path route 38 at blocks 104 and 106, updating the model of road brightness metrics at identified road segments 38A, 38B, 38C, 38D, 38E, 38F, 40B, 40C, 40D, 40E, 40F at different times and different dates.

A system 10 and method 100 of the present disclosure provides many advantages. Travelling on more well-lighted roadways is safer. There is less chance of vehicle-animal and vehicle-pedestrian accidents when traveling on well-lighted roads, due to the fact that a driver of a vehicle cannot see animals and pedestrians as well when lighting conditions are poor. Further, the system described herein, can make a driver and passengers of a vehicle more comfortable. For some, it is more comfortable to travel when lighting is good, and such individuals feel dis-comfort and anxiety when travelling via darker routes. During the summer, an individual may prefer to drive on a more shaded (darker) route, and in the winter, an individual may prefer to drive on a less dark route that receives more sunshine. The system of the present disclosure may also be used to improve automatic high-beam systems.

Another use of a system of the present disclosure is by the department of transportation (DOT) or other such organizations. A provider of a system in accordance with the present disclosure could provide commercial access to the historical data stored within the cloud-based data processor so such organizations can identify areas within a community or city that have poor lighting conditions, and plan future infrastructure repairs/updates based on such information.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A system for providing route guidance based on road brightness metrics, comprising:
a primary vehicle having an on-board data processor, a driver interface in communication with the on-board data processor and adapted to allow a driver of the vehicle to receive information from the on-board data processor and to input information to the on-board data processor, and a wireless communication module in communication with the on-board data processor;
a cloud-based data processor adapted to collect real-time road brightness data from the primary vehicle and a plurality of other vehicles and to store collected road brightness data from the primary vehicle and the plurality of other vehicles and to build a model of road brightness metrics at identified road segments at different times and different dates;
the cloud-based data processor further adapted to:
receive data related to a starting position and final destination of the primary vehicle from the on-board data processor within the primary vehicle;
calculate brightness characteristics for a shortest path route between the starting point and the final destination;
calculate brightness characteristics for at least one viable alternate route between the starting point and the final destination; and
present to a driver of the primary vehicle, via the driver interface within the primary vehicle, the at least one viable alternate route between the starting point and the final destination, when the at least one viable alternate route has brightness characteristics which satisfy pre-determined brightness preferences better than the shortest path route between the starting point and the final destination.

2. The system of claim 1, wherein when calculating brightness characteristics for at least one viable alternate route between the starting point and the final destination, the cloud-based data processor is further adapted to identify at least one viable alternate route that has an arrival time within a pre-determined time internal of an arrival time for the shortest path route.

3. The system of claim 2, wherein the cloud-based data processor is further adapted to collect real-time data related to brightness characteristics for the at least one viable alternate route from other vehicles traveling on the at least one alternate route, wherein, when calculating brightness characteristics for the at least one viable alternate route between the starting point and the final destination, the cloud-based data processor is adapted to combine historical data stored within the model of road brightness metrics on the cloud-based data processor related to brightness characteristics of the at least one viable alternate route with the real-time data collected from other vehicles traveling on the at least one alternate route.

4. The system of claim 3, wherein the cloud-based data processor is further adapted to collect real-time data related to brightness characteristics for the shortest path route from other vehicles traveling on the shortest path route and from the primary vehicle, wherein when calculating brightness characteristics for the shortest path route between the starting point and the final destination, the cloud-based data processor is further adapted to combine historical data stored within the model of road brightness metrics on the cloud-based data processor related to brightness characteristics of the shortest path route with the real-time data collected from other vehicles traveling on the shortest path route and from the primary vehicle.

5. The system of claim 4, wherein the on-board data processor within the primary vehicle and on-board data processors within each of the other vehicles are adapted to:
collect images from a plurality of on-board image capturing devices;
calculate, with the on-board data processor, a brightness metric for each captured image from each of the plurality of image capturing devices;
calculate a median brightness metric for the captured images over the identified road segments;
attach GPS coordinates, heading information and timestamps to the median brightness metrics; and
send, via a wireless communication module, over a wireless communication network, the median brightness metrics to the cloud-based data processor.

6. The system of claim 5, wherein the on-board data processors within each of the primary vehicle and the other vehicles are adapted to ROI filter each of the captured images from each of the plurality of image capturing devices prior to calculating the brightness metric for each captured image.

7. The system of claim 5, wherein when combining historical data stored within the model of road brightness metrics on the cloud-based data processor related to brightness characteristics of the at least one viable alternate route with the real-time data collected from other vehicles traveling on the at least one alternate route, the cloud-based data processor is further adapted to identify the plurality of identified road segments of the at least one viable alternate route, and for each of the identified road segments of the at least one viable route, fuse the median brightness metrics for each of the identified road segments received from the other vehicles with historical data for each of the identified road segments stored within the model of road brightness metrics on the cloud-based data processor to calculate brightness characteristics for each of the plurality of pre-determined road segments of the at least one alternate route.

8. The system of claim 7, wherein when combining historical data stored within the model of road brightness metrics on the cloud-based data processor related to brightness characteristics of the shortest path route with the real-time data collected from other vehicles traveling on the shortest path route and from the primary vehicle, the cloud-based data processor is further adapted to identify the plurality of identified road segments of the shortest path route, and for each of the identified road segments of the shortest path route, fuse the median brightness metrics for each of the identified road segments received from other vehicles and the primary vehicle with historical data for the identified road segments stored within the model of road brightness metrics on the cloud-based data processor to calculate brightness characteristics for each of the plurality of pre-determined road segments of the shortest path route.

9. The system of claim 8, wherein when presenting to the driver of the primary vehicle, via a driver interface within the primary vehicle, the at least one viable alternate route between the starting point and the final destination, when the at least one viable alternate route has brightness characteristics which satisfy pre-determined brightness preferences better than the shortest path route between the starting point and the final destination, the cloud-based data processor is further adapted to:
collect, with the driver interface within the primary vehicle, driver preferences related to brightness metrics;
compare each of the identified road segments of the at least one viable alternate route with the driver preferences;
compare each of the identified road segments of the shortest path route with the driver preferences; and
identify each of the at least one viable alternate route that more closely satisfies the driver preferences than the shortest path route.

10. The system of claim 9, wherein, after calculating brightness characteristics for each of the plurality of pre-determined road segments of the at least one alternate route and calculating brightness characteristics for each of the plurality of identified road segments of the shortest path route, the cloud-based data processor is further adapted to update the model of road brightness metrics at identified road segments at different times and different dates.

11. A method of providing route guidance based on road brightness metrics, comprising:
collecting, with a cloud-based data processor adapted to collect real-time road brightness data from the primary vehicle and a plurality of other vehicles and to store collected road brightness data from the primary vehicle and the plurality of other vehicles and to build a model of road brightness metrics at identified road segments at different times and different dates, a starting position and final destination of a primary vehicle from a processor within the primary vehicle;
calculating brightness characteristics for a shortest path route between the starting point and the final destination;
calculating brightness characteristics for at least one viable alternate route between the starting point and the final destination; and
presenting to the driver of the primary vehicle, via a driver interface within the primary vehicle, the at least one viable alternate route between the starting point and the final destination, when the at least one viable alternate route has brightness characteristics which satisfy pre-determined brightness preferences better than the shortest path route between the starting point and the final destination.

12. The method of claim 11, wherein the calculating brightness characteristics for at least one viable alternate route between the starting point and the final destination further includes identifying at least one viable alternate route that has an arrival time within a pre-determined time internal of an arrival time for the shortest path route.

13. The method of claim 12, wherein the calculating brightness characteristics for the at least one viable alternate route between the starting point and the final destination further includes:
collecting, with the cloud-based data processor, real-time data related to brightness characteristics for the at least one viable alternate route from other vehicles traveling on the at least one alternate route; and
combining historical data stored within the model of road brightness metrics on the cloud-based data processor related to brightness characteristics of the at least one viable alternate route with the real-time data collected from other vehicles traveling on the at least one alternate route.

14. The method of claim 13, wherein the calculating brightness characteristics for the shortest path route between the starting point and the final destination further includes:
collecting, with the cloud-based data processor, real-time data related to brightness characteristics for the shortest path route from other vehicles traveling on the shortest path route and from the primary vehicle; and
combining historical data stored within the model of road brightness metrics on the cloud-based data processor related to brightness characteristics of the shortest path route with the real-time data collected from other vehicles traveling on the shortest path route and from the primary vehicle.

15. The method of claim 14, wherein the collecting, with the cloud-based data processors within the primary vehicle and each of the other vehicles, real-time data from the primary vehicle and the other vehicles, further includes:
collecting images from a plurality of on-board image capturing devices with an on-board data processor;
calculating, with the on-board data processor, a brightness metric for each captured image from each of the plurality of image capturing devices;
calculating a median brightness metric for the captured images over the identified road segments;
attaching GPS coordinates, heading information and timestamps to the median brightness metrics; and
sending, via a wireless communication module, over a wireless communication network, the median brightness metrics to the cloud-based data processor.

16. The method of claim 15, further including ROI filtering each of the captured images from each of the plurality of image capturing devices prior to calculating the brightness metric for each captured image.

17. The method of claim 15, wherein the combining historical data stored within the model of road brightness metrics on the cloud-based data processor related to brightness characteristics of the at least one viable alternate route with the real-time data collected from other vehicles traveling on the at least one alternate route further includes:
identifying, with the cloud-based data processor, the identified road segments of the at least one viable alternate route, and for each of the identified road segments of the at least one viable route, fusing the median brightness metrics for each of the identified road segments received from other vehicles with historical data for each of the identified road segments stored within the model of road brightness metrics on the cloud-based data processor to calculate brightness characteristics for each of the plurality of identified road segments of the at least one alternate route.

18. The method of claim 17, wherein the combining historical data stored within the model of road brightness metrics on the cloud-based data processor related to brightness characteristics of the shortest path route with the real-time data collected from other vehicles traveling on the shortest path route and from the primary vehicle further includes:
identifying, with the cloud-based data processor, the identified road segments of the shortest path route, and for each of the identified road segments of the shortest path route, fusing the median brightness metrics for each of the identified road segments received from other vehicles and the primary vehicle with historical data for the identified road segments stored within the model of road brightness metrics on the cloud-based data processor to calculate brightness characteristics for each of the plurality of identified road segments of the shortest path route.

19. The method of claim 18, wherein the presenting to the driver of the primary vehicle, via a driver interface within the primary vehicle, the at least one viable alternate route between the starting point and the final destination, when the at least one viable alternate route has brightness characteristics which satisfy pre-determined brightness preferences better than the shortest path route between the starting point and the final destination further includes:
collecting, with the driver interface within the primary vehicle, driver preferences related to brightness metrics;
comparing each of the identified road segments of the at least one viable alternate route with the driver preferences;
comparing each of the identified road segments of the shortest path route with the driver preferences; and
identifying each of the at least one viable alternate route that more closely satisfies the driver preferences than the shortest path route.

20. The method of claim 19, further including, after calculating brightness characteristics for each of the plurality of identified road segments of the at least one alternate route and calculating brightness characteristics for each of the plurality of identified road segments of the shortest path route, updating the model of road brightness metrics at identified road segments at different times and different dates.
